(19) United States
(12) Patent Application Publication
(10) Pub. No.: US 2014/0360026 A1
(43) Pub. Date: Dec. 11, 2014

(54) CUTTING HEAD OF A GRASS TRIMMER

(71) Applicant: CHERVON (HK) LIMITED, Wanchai (HK)

(72) Inventors: Toshinari Yamaoka, Nanjing (CN); Hanzheng Li, Nanjing (CN)

(21) Appl. No.: 14/295,634

(22) Filed: Jun. 4, 2014

(30) Foreign Application Priority Data
Jun. 9, 2013 (CN) 201310229816.7
Jul. 5, 2013 (CN) 201310283731.7

(51) Int. Cl. A01D 34/416

(52) U.S. Cl. CPC A01D 34/416
USPC 30/276

(57) ABSTRACT

A cutting head for use with a cutting tool, such as a grass trimmer. The cutting head has a housing, a line spool and a supporting cap. One end of the housing is coupled to an end of a motor output shaft and another end has an opening. A line spool is disposed in the housing and rotates along with the housing. At least one end of a line wound around the line spool extends out of the housing. The supporting cap is rotatably disposed at the end of the line spool adjacent to the opening and is exposed to an exterior of the housing through the opening.

### RELATED APPLICATION INFORMATION

This application claims the benefit of CN 201310229816.7, filed on Jun. 9, 2013, and CN 201310283731.7, filed on Jul. 5, 2013, the disclosures of which are incorporated herein by reference in their entirety.

### FIELD OF THE DISCLOSURE

The present disclosure relates to the field of gardening power tools and, more particularly, to a cutting head of a grass trimmer.

### BACKGROUND

A grass trimmer is a universal and practical gardening tool, and is particularly adapted to trim grass at a location such as a villa lawn and a garden lawn. Grass trimmers currently available in the market are roughly classified into the following types: bump line feed, automatic line feed, and manual line feed. When a grass trimmer feeds line by bumping, a user needs to bump the head of the trimmer to contact the ground to loosen engagement between a line spool and a housing to feed line. During line feed, the bumping head rotates together with the line spool. Since the bumping head contacts the ground, it is subjected to wear from the ground during rotation, and furthermore, output power of the motor is increased and service life of the battery is affected.

Regarding cutting heads with automatic line feed and manual line feed, an operator unconsciously causes the cutting head to contact the ground frequently during practical use, which inevitably accelerates wear of the cutting head which is rotating at a high speed, increases the power consumption of the grass trimmer and affects the performance of the motor. Although instructions to avoid contacting the bumping cap with the ground are provided in the specification of many grass trimmer products, this still cannot fundamentally solve the above issues.

### SUMMARY

In order to solve the above problems, hereinafter is described an anti-wear cutting head structure which prolongs the service life of the cutting head, reduces the output power consumption of the motor, and improves a user's comfort in use.

To achieve the above objects, a cutting head, which is connected to a motor output shaft of a grass trimmer, includes a housing, a line spool and a supporting cap. One end of the housing is connected to an end of the motor output shaft, and the other end thereof has an opening. The line spool is disposed in the housing and rotates along with the housing, and at least one end of a line wound around the line spool extends out of the housing. The supporting cap is rotatably disposed at the end of the line spool adjacent to the opening and exposed to an exterior of the housing through the opening.

Furthermore, the housing may comprise an upper cover and a lower cover which are fixed by snap fitting, and the upper cover may be mounted to the end portion of the motor output shaft and the lower cover may have an opening.

Furthermore, the line spool may be disposed in a cavity formed by the upper cover and the lower cover and may rotate along with the lower cover.

Furthermore, the cutting head may further comprise a compression spring with one end abutting against the line spool and the other end abutting against the upper cover.

Furthermore, the end of the line spool may be provided with a mounting hole and the supporting cap may be provided with a protrusion, wherein a clearance fit is formed between the protrusion and the mounting hole, and the locations of the protrusion and the mounting hole are relatively fixed along the direction of the motor output shaft.

Furthermore, a bearing may be disposed between the mounting hole and the protrusion.

Furthermore, the opening may have a circumferential flange and the supporting cap may have a circumferential flange edge disposed between the flange and the end of the line spool, wherein a clearance fit is formed between the flange and the end of the line spool.

Furthermore, a washer may be provided between the flange and the flange edge.

A further described cutting head, which is also connected to a motor output shaft of a grass trimmer, includes a housing, a line spool and a supporting cap. One end of the housing is connected to an end of the motor output shaft. The line spool is disposed in the housing and rotates along with the housing and at least one end of a line wound around the line spool extends to an exterior of the housing. The supporting cap is rotatably disposed at the other end of the housing.

Furthermore, the housing may include an upper cover and a lower cover which are fixed by snap fitting and the upper cover may be mounted to the end of the motor output shaft, wherein the line spool is disposed in a cavity formed by the upper cover and the lower cover and rotates along with the lower cover.

Furthermore, the supporting cap may be rotatably disposed at the lower cover and the locations of the supporting cap and the lower cover may be relatively fixed along the direction of the motor output shaft.

Furthermore, the lower cover may be provided with an engaging hole and the supporting cap may be provided with a mounting portion, wherein a clearance fit is formed between the engaging hole and the mounting portion, and the locations of the engaging hole and the mounting portion are relatively fixed along the direction of the motor output shaft.

Furthermore, a bearing may be provided between the engaging hole and the mounting portion.

With the supporting cap freely rotatable relative to the line spool or the lower cover being provided, the described cutting head avoids increases of load when the cutting head feeds line by bumping the ground or otherwise drags on the ground during operation, slows down the wear speed of the supporting cap, thereby prolonging the service life of the cutting head, reducing the output power consumption of the motor, extending the service life of a battery pack, and improving the user's comfort in use.

### BRIEF DESCRIPTION OF DRAWINGS

FIG. 1 is an exploded view of a cutting head constructed according to the description which follows.

FIG. 2 is a partial cross-sectional view of the cutting head of FIG. 1 after being assembled.

FIG. 3 is a partial cross-sectional view of an assembled cutting head constructed according to the description which follows.

FIG. 4 is a partial cross-sectional view of an assembled cutting head constructed according to the description which follows.

FIG. 5 is a partial cross-sectional view of an assembled cutting head constructed according to the description which follows.

### DETAILED DESCRIPTION

The subject cutting head will now be described in detail with reference to figures.

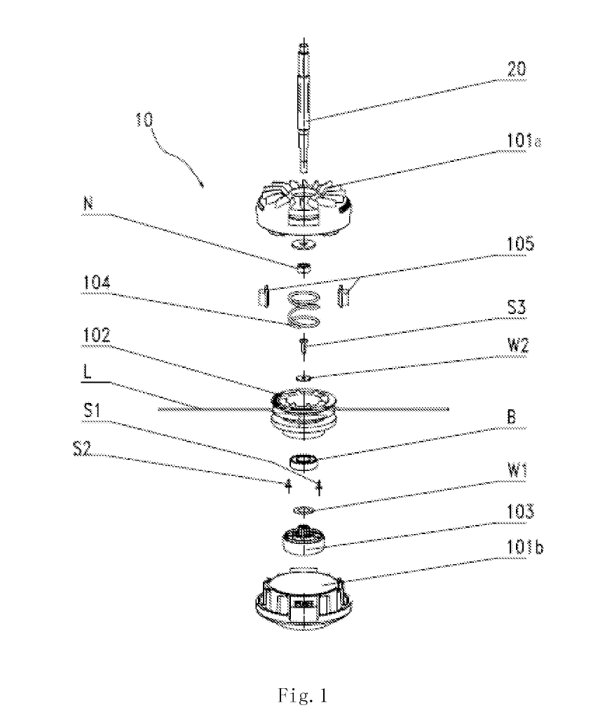

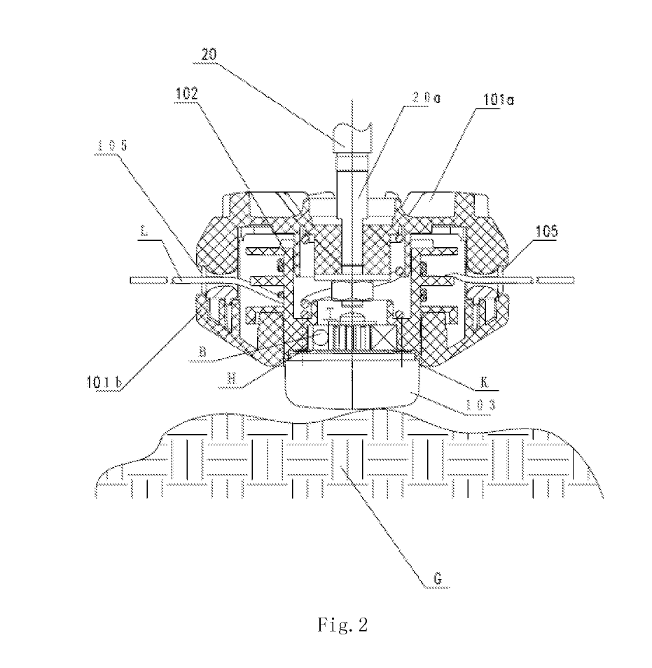

FIG. 1 is an exploded view of an exemplary cutting head. FIG. 2 is a partial cross-sectional view of the cutting head of FIG. 1 after being duly assembled. Referring to FIG. 1 and FIG. 2, parts except for a motor shaft and a tapping cap are shown in the cross-sectional view, and a cutting head 10 is connected to a motor output shaft 20 of a grass trimmer.

The cutting head 10 includes a housing 101, a line spool 102, a supporting cap 103 and a compression spring 104. In the present embodiment, the housing 101 includes an upper cover 101a and a lower cover 101b which are fixed by snap fitting. The upper cover 101a is mounted to an end portion 20a of the motor output shaft 20 via a nut N, and the lower cover 101b has an opening K. The line spool 102 is disposed in a cavity formed by the upper cover 101a and the lower cover 101b, and ribs on the lower cover 101b cooperate with ribs on the line spool 102 so that the line spool rotates along with the lower cover 101b, and an end of a line L wound around the line spool 102 extends out of the housing 101 through a line-running block 105. An upper end of the compression spring 104 abuts against the line spool 103, and a lower end of the compression spring 104 abuts against the upper cover 101a.

In this illustrated design, an end of the line spool 102 is provided with a mounting hole H, and the supporting cap 103 is provided with a protrusion T. A bearing B is disposed between the mounting hole H and the protrusion T, and the bearing B is fixed to a lower end of the line spool 102 via an annular washer W and screws S1 and S2. An inner ring of the bearing B cooperates with the protrusion T and an outer ring of the bearing B cooperates with the mounting hole H, and the protrusion T is locked with the bearing B via a screw S3 and a washer W2 so that locations of the supporting cap 103 and the line spool 102 are relatively fixed along the direction of the motor output shaft 20.

When the line is fed by bumping the ground or when the user brings the cutting head into contact with the ground G accidently, the supporting cap 103 contacts the ground. In this way, even if the line spool 102 or the cutting head rotates at a high speed, torsion will not be transferred between the supporting cap 103 and the line spool 102 as the bearing B is provided between the supporting cap 103 and the line spool 102, thereby not hindering normal rotation of the cutting head. This finally avoids increase of the motor load and influence on the service life of the motor when the cutting head feeds line by bumping or otherwise drags on the ground during operation, and meanwhile, this slows down the wear speed of the supporting cap 103.

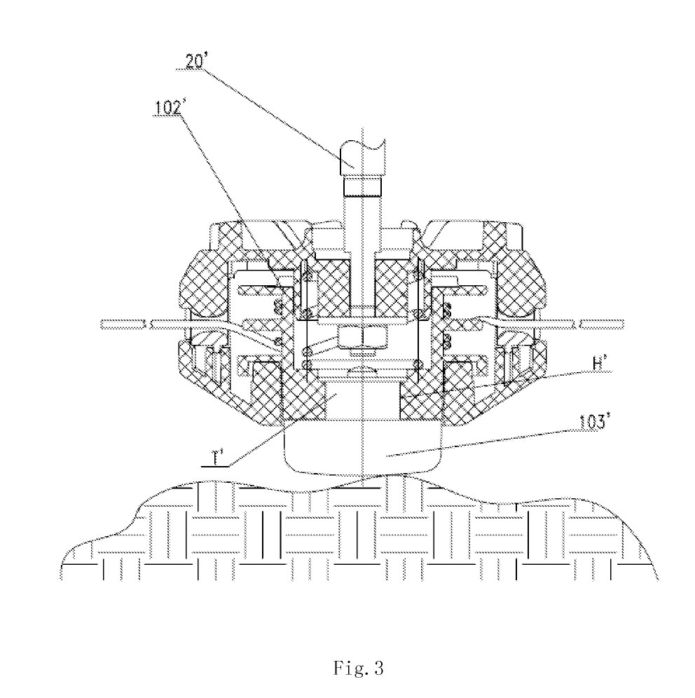

It is to be understood that the above illustrated and described cutting head is merely exemplary and is not intended to limit the scope of the invention claimed hereinafter. In this regard, it will be understood that the connectional relationship of the supporting cap 103 and the lower end of the line spool 102 may be implemented in other manners, for example, as shown in FIG. 3. In FIG. 3, the structures are generally similar to those set forth above and will not be detailed here excepting that a bearing is not provided between a protrusion T′ of a supporting cap 103′ and a mounting hole H′ of a line spool 102′. Instead, a clearance fit is formed between the protrusion T′ of the supporting cap 103′and the mounting hole H′ of the line spool 102′, whereby the two may rotate relative to each other, and they do not move relative to each other in an axial direction of the mounting hole H′. As such, when the line is fed by bumping the ground or the user brings the cutting head into contact with the ground accidently, the supporting cap 103′ will not transfer the torsion to the line spool 102′ to hinder the normal rotation of the cutting head.

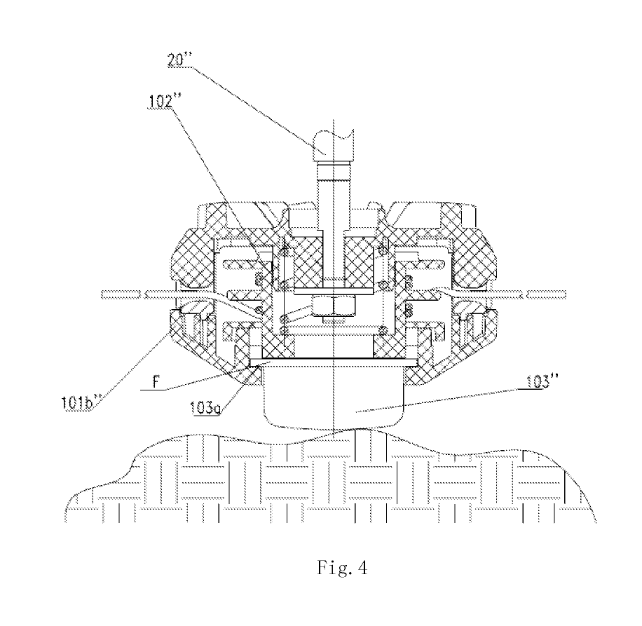

In the cutting head shown in FIG. 4, the remaining structures are again similar to those described above excepting that an opening of a lower cover 101b″ has a circumferential flange 103a and the supporting cap 103″ has a circumferential flange edge F. The flange edge F is disposed between the flange 103a and a lower end of the line spool 102″ and a clearance fit is formed between the flange 103a and the lower end of the line spool 102″. Such arrangement may achieve relative rotation between the supporting cap 103″ and the line spool 102″ and limit relative movement between the supporting cap 103″ and the line spool 102″ along the direction of the motor output shaft. Furthermore, a washer (not shown) may be provided between the flange and the flange edge to reduce the wear of the flange and the flange edge.

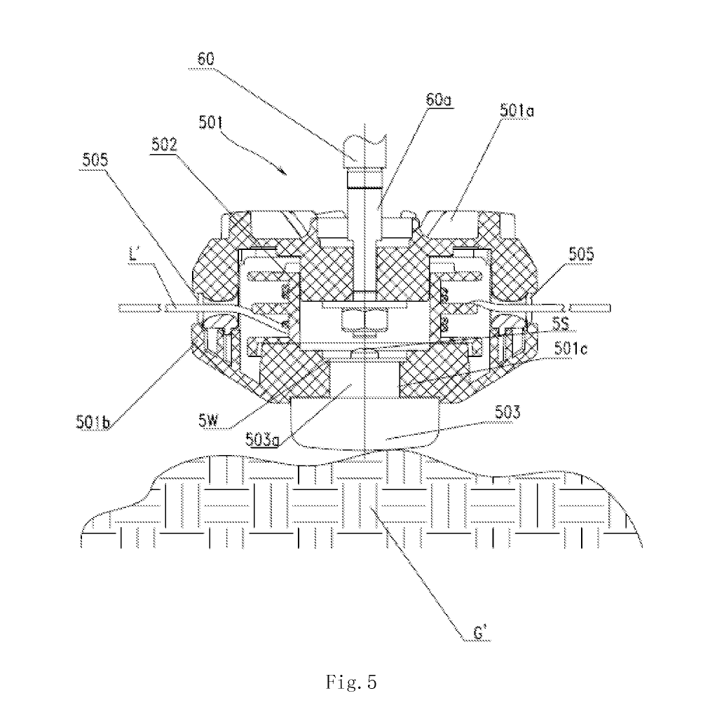

The above described cutting heads all exemplify a cutting head which feeds line by bumping the ground. Hereafter, a cutting head which feeds line automatically is taken as an example for illustration, as shown in FIG. 5.

The automatic line feeding structure of the cutting head is well known by those having ordinary skill in the art and need not be described in detail herein. A cutting head 50 is connected to a motor output shaft 60 of the grass trimmer. The cutting head 50 includes a housing 501, a line spool 502 and a supporting cap 503. The housing 50 includes an upper cover 501a and a lower cover 501b which are fixed by snap fitting, and the upper cover 501a is mounted to a lower end 60a of the motor output shaft 60. The line spool 502 is disposed in a cavity formed by the upper cover 501a and the lower cover 501b, and an end of a line L′ wound around the line spool 502 extends out of the housing 501. Movable ribs on the cover 501a cooperate with ribs on the line spool 502 so that the line spool rotates along with the lower cover 501b, and the end of the line L′ wound around the line spool 502 extends out to an exterior of the housing 501 through a line-running block 505. The lower cover 501b is provided with an engaging hole 501c, and the supporting cap 503 is provided with a mounting portion 503a. A clearance fit is formed between the engaging hole 501c and the mounting portion 503a, and the mounting portion 503a is locked via a washer 5W and a screw 5S so that locations of the engaging hole 501c and the mounting portion 503a are relatively fixed along the direction of the motor output shaft 60.

When the user causes the cutting head 50 to contact the ground G′ accidently, the supporting cap first contacts the ground. As a clearance fit is formed between the engaging hole 501c and the mounting portion 503a, the supporting cap is freely rotatable and will not transfer the torsion to the lower cap so that normal operation of the cutting head is not hindered, the output power consumption of the motor is not affected, and the wear of the cutting head upon touching the ground is reduced.

Furthermore, it will be understood that a bearing can be provided between the engaging hole and the mounting portion which are mounted on a similar mounting principle to the line spool and the supporting cap described with respect to FIG. 1. The relevant rotational relationship between the supporting cap and the lower cover is implemented by the provision of the bearing so that when the user inadvertently causes the cutting head to touch the ground, the supporting cap will not transfer the torsion to the lower cap, thus the normal operation of the cutting head is not hindered and the output power consumption of the motor is not affected.

Any of the above described cutting heads may be applied to a grass trimmer. The structure of the grass trimmer need not be described in detail herein.

To conclude, with the supporting cap freely rotatable relative to the line spool or the lower cover being provided, the cutting head according to the descriptions presented herein avoids increases of load when the cutting head feeds line by tapping the ground or otherwise drags on the ground during operations, slows down the wear speed of the supporting cap, thereby prolonging the service life of the cutting head, reducing the output power consumption of the motor and improving the user's comfort in use.

The above illustrates and describes basic principles, main features and advantages of the present invention. Those skilled in the art should understand that the above descriptions are not intended to limit the present invention in any form, and all technical solutions obtained by employing equivalent substitutions or equivalent variations are to fall within the protection scope of the present invention.

What is claimed is:

1. A cutting head connected to a motor output shaft of a grass trimmer, the cutting head comprising:
a housing having one end coupled to an end of the motor output shaft and another end having an opening;
a line wound around a line spool, wherein the line spool is disposed in the housing and rotates along with the housing and wherein at least one end of the line wound around the line spool extends out of the housing; and
a supporting cap rotatably disposed at the end of the line spool adjacent to the opening and exposed to an exterior of the housing through the opening.

2. The cutting head according to claim 1, wherein the housing comprises an upper cover and a lower cover which are fixed by snap fitting and wherein the upper cover is coupled to the end of the motor output shaft and the lower cover has the opening.

3. The cutting head according to claim 2, wherein the line spool is disposed in a cavity formed by the upper cover and the lower cover and rotates along with the lower cover.

4. The cutting head according to claim 2, wherein the cutting head further comprises a compression spring having one end abutting against the line spool and another end abutting against the upper cover.

5. The cutting head according to claim 1, wherein an end of the line spool is provided with a mounting hole, and the supporting cap is provided with a protrusion, a clearance fit is formed between the protrusion and the mounting hole, and the locations of the protrusion and the mounting hole are relatively fixed along the direction of the motor output shaft.

6. The cutting head according to claim 5, wherein a bearing is disposed between the mounting hole and the protrusion.

7. The cutting head according to claim 1, wherein the opening has a circumferential flange, and the supporting cap has a circumferential flange edge disposed between the flange and an end of the line spool, wherein a clearance fit is formed between the flange and the end of the line spool.

8. The cutting head according to claim 7, wherein a washer is provided between the flange and the flange edge.

9. A cutting head connected to a motor output shaft of a grass trimmer, the cutting head comprising:
a housing having one end coupled to an end of the motor output shaft;
a line wound around a line spool, wherein the line spool is disposed in the housing and rotates along with the housing and wherein at least one end of the line wound around the line spool extends to an exterior of the housing; and
a supporting cap rotatably disposed at another end of the housing.

10. The cutting head according to claim 9, wherein the housing comprises an upper cover and a lower cover which are fixed by snap fitting, wherein the upper cover is coupled to the end of the motor output shaft, and wherein the line spool is disposed in a cavity formed by the upper cover and the lower cover and rotates along with the lower cover.

11. The cutting head according to claim 10, wherein the supporting cap is rotatably disposed on the lower cover and the locations of the supporting cap and the lower cover are relatively fixed along the direction of the motor output shaft.

12. The cutting head according to claim 11, wherein the lower cover is provided with an engaging hole and the supporting cap is provided with a mounting portion, wherein an interference clearance fit is formed between the engaging hole and the mounting portion, and wherein the locations of the engaging hole and the mounting portion are relatively fixed along the direction of the motor output shaft.

13. The cutting head according to claim 12, wherein a bearing is provided between the engaging hole and the mounting portion.
